(19) United States
(12) Patent Application Publication
(10) Pub. No.: US 2012/0312562 A1
(43) Pub. Date: Dec. 13, 2012

(54) METHOD FOR FIGHTING AND/OR PREVENTING FIRES IN LITHIUM ION CELLS AND LITHIUM ION POLYMER CELLS

(76) Inventors: Thomas Woehrle, Stuttgart-Feuerbach (DE); Werner Denninger, Stuttgart (DE); Dieter Schmidt, Ditzingen (DE); Rainer Kern, Stuttgart (DE)

(21) Appl. No.: 13/388,660

(22) PCT Filed: Jul. 2, 2010
(86) PCT No.: PCT/EP10/59437

§ 371 Date: Aug. 20, 2012

(30) Foreign Application Priority Data
Aug. 3, 2009 (DE) 10-2009-035.908.7

(51) Int. Cl. A62D 1/00; A62C 3/16; A62C 99/00; A62C 3/06

(52) U.S. Cl. 169/46; 252/2; 169/54; 169/51

(57) ABSTRACT

A method for fighting and/or preventing a fire in one or more battery cells, preferably lithium ion cells, using a hydrous solution of calcium salts and a fire extinguishing gel.

### PRIOR ART

Lithium ion cells are playing an ever-greater part in diverse fields of use. Lithium ion batteries are known and in widespread use for electronic devices, such as cell phones, laptops, power tools, portable MP3 players, etc. Lithium ion batteries whose application lies in the automobile sector will likewise play a large part in the near future. Lithium ion polymer cells are lithium ion cells which are packaged in composite aluminum foil. Only the term “lithium ions” is used below.

Failure of batteries, particularly of lithium ion batteries, may be accompanied by the emergence from the battery interior of chemicals and particles. This liberated material then takes the form of particulates, dust, foil, aerosol, liquid, droplet mist and/or gas, and at the location of emergence is usually very hot. This material is in some cases highly reactive and injurious to health. The liberated material may condense on surrounding surfaces and thus contaminates the surrounding area. The liberated material may also be injurious to the health of individuals. It is also possible for the liberated material to ignite, and for fire and/or explosion events to occur.

Virtually all lithium ion batteries use lithium hexafluorophosphate (LiPF₆) as conductive salt, which, in the event of battery damage (e.g., in the case of thermal runaway) may be decomposed to form highly reactive and toxic compounds. The literature (see, for example, Hui Yang, Guorong V. Zhuang, Philip N. Ross Jr “Thermal Stability of LiPF₆ Salt and Li-ion Battery Electrolytes Containing LiPF₆” Lawrence Berkeley National Laboratory (University of California, University of California), 2006 Paper LBNL-58758) cites decomposition products even from temperatures of around 110° C. as being the highly reactive compounds PF₃ (phosphorus trifluoride), PF₅ (phosphorus penta-fluoride), HF (hydrogen fluoride), also known as hydrofluoric acid), and POF₃ (phosphorus oxytri-fluoride). Furthermore, other toxic and corrosive phosphorus/oxygen/fluorine compounds may occur. Besides these, organofluorine compounds, in traces, are likely as well.

The thermal decomposition of LiPF₆ in the absence of water takes place, from temperatures of around 110° C., in accordance with the following reaction:

LiPF₆→LiF(s)+PF₅(g),

where s stands for solid and g stands for gaseous.

In the presence of water, the lithium hexafluorophosphate undergoes hydrolysis as follows:

LiPF₆+2H₂O →LiOH(s)+POF₃(g)+3HF(g)

In principle, moreover, the following hydrolysis reactions must be borne in mind:

PF₅+H₂O POF₃+2HF

POF₃+3 H₂O H₃PO₄+3HF

This means that the phosphorus oxytrifluoride formed as an intermediate, as well, ultimately undergoes hydrolysis to form highly reactive hydrogen fluoride (HF) by reaction with water, in the form of atmospheric moisture, for example.

As a general rule, during usage and testing of batteries, especially lithium ion batteries, the failure of the batteries is technically prevented. If, nevertheless, such battery failure occurs, and there is a fire or “thermal runaway”, then measures are needed for fire control and for avoiding contamination of the surroundings. In thermal runaway in a lithium ion cell, excessive and self-reinforcing production of heat in the cell and/or inadequate removal of heat may be accompanied by opening of the cell, with the additional possibilities of smoke development, fire phenomenon or an explosion. With regard to the subject of thermal runaway of lithium ion cells, reference is made to the following literature: Kern, R.; Bindel R.; Uhlenbrock R.; Durchgängiges Sicherheitskonzept für die Prüfung von Lithium-Ionen-Batteriesystemen; [Comprehensive safety approach for the testing of lithium-ion battery systems]; ATZelektronik, in press.

To date no approach has been disclosed to the extinguishing or fire control of lithium ion batteries that not only achieves good extinguishment outcomes but at the same time also prevents, or at least restricts, the contamination of the environment with highly reactive compounds from the damaged cell or battery.

### DISCLOSURE OF THE INVENTION

Provided in accordance with the invention is a method for controlling and/or preventing a fire in one or more battery cells, preferably lithium ion cells. The characteristic feature of the method of the invention is that an aqueous solution of a calcium (Ca) salt and a gel extinguishant are applied.

It has emerged, surprisingly, that the use of an aqueous solution of a calcium salt, more particularly a 20% strength CaCl₂ solution, in conjunction with the concurrent use of a gel extinguishant having good cooling properties, results in a good extinguishment effect and, at the same time, in a surprisingly sharp reduction in the release of reactive compounds from damaged lithium ion cells; moreover, as a result of the cooling effect of the gel component, a reduction became apparent in a transfer of the heat and/or flames from one lithium ion cell to one of its neighbors. The calcium ion from the aqueous solution of a calcium salt is able to bind fluoride ions and hydrofluoric acid (HF) and fluoride-containing species such as phosphorus oxytrifluoride (POF₃), especially in the form of calcium fluoride (CaF₂), which is virtually water-insoluble and therefore precipitates. Accordingly it is possible for liberated fluoride ions and hydrogen fluoride (HF) and also species such as POF₃ to be converted safely and very extensively into a nonhazardous form.

The method of the invention is suitable for controlling and/or preventing a fire in one or more battery cells, more particularly lithium ion cells, modules, batteries or accumulators. The term “battery” refers here to electrochemical energy storage devices, more particularly batteries or accumulators, of all customary battery technologies. The cells, modules, batteries or accumulators are preferably of the Li ion (lithium ion) or LiPo (referred to as lithium polymer or lithium ion polymer) type. The following terms reflect examples of active materials which are employed in these lithium ion cells: Li₂Mn₂O₄ (LMO), referred to as lithium manganese spinel; LiFePO₄ (LFP), lithium iron phosphate, and Li₄Ti₅O₁₂ (LiTiO), lithium titanate. The extinguishant of the invention can be applied for all lithium ion cells with all active materials. The term “battery” is used here not only for individual cells but also for modules composed of two or more cells, and additionally for more complex architectures encompassing a plurality of cells and/or modules.

Preference is given to using high-capacity batteries having a nominal capacity of at least 3 Ah. The indicated nominal capacity values here may relate either to the entire intake battery or to an individual cell of a battery.

The batteries preferably comprise, partly or exclusively, lithium ion cells and/or lithium ion polymer cells, modules and/or batteries having a nominal capacity of at least 3 Ah per cell.

By controlling a fire in one or more battery cells is meant not only the extinguishing of a fire but also the inhibition of a fire or of a temperature increase, or the prevention or inhibition of propagation of the fire to other parts of the battery cell, the battery and/or the environment, and also the prevention and/or inhibition of the formation, spread and/or release of toxic and/or reactive ingredients of the battery or battery cell, or products of such ingredients and environmental substances.

By prevention are meant measures which are undertaken before the onset of a fire event and which may result in a fire in one or more battery cells not developing at all or taking place only with reduced intensity. For example, battery cells in an undefined state may be treated on a precautionary basis with an aqueous solution of a calcium salt and with a gel extinguishant before they are transported and/or stored, in order to lessen the risk of a battery fire.

The method of the invention is characterized in that an aqueous solution of a Ca salt is applied. The Ca salt is a salt in which Ca is present in the 2+ oxidation state. The salt of the aqueous solution may comprise or consist of an organic salt, preferably a salt of Ca²⁺ and a low alkyl or carboxylic acid, e.g., a C1 to C4 alkyl or carboxylic acid. The salt of the aqueous solution may preferably comprise or consist of an inorganic Ca salt. Particularly preferred are CaCl₂ or Ca(OH)₂ or a mixture thereof. Especially preferred is an aqueous CaCl₂ solution.

In the aqueous solution the Ca salt is present in a concentration which allows Ca ions of the aqueous solution to bind fluoride ions which come from the damaged battery cell, to form CaF₂. The amount of Ca salt here does not exceed a concentration at which the aqueous solution is saturated with Ca salt. The Ca salt is preferably present in a concentration in the aqueous solution of at least 1% w/v (weight per volume) up to and including a concentration at which a saturated solution is formed, more preferably of 5% w/v up to and including 40% w/v, more preferably of 10% w/v to 30% w/v, very preferably of 20% w/v.

In the aqueous solution the Ca salt is in solution in an aqueous solvent. The aqueous solvent is preferably water or solvent mixtures having a water fraction of more than 20%, preferably of more than 50%. However, other solvents or solvent mixtures may also be used. The solvent is liquid at room temperature and the Ca salt used is fully soluble in the solvent up to the desired concentration. The solvent itself is also distinguished by the fact that it is per se not combustible and is inert toward the Ca salt.

In the method of the invention, as well as the aqueous solution of a Ca salt, a gel extinguishant is applied. The gel extinguishant comprises a water-absorbing polymer and is able by incorporation of water to form what is called a hydrogel. The water-absorbing polymer is present in the gel extinguishant preferably in a concentration of 0.5% to 10% (w/v), more preferably of 1.5% to 3% (w/v). The gel extinguishant is notable for the fact that it is able to take up and bind water and that, after application has taken place, on the article undergoing extinguishment, it ensures that the water cannot flow away immediately from the seat of the fire. The use of a gel extinguishant of this kind not only means that the water consumption is lowered and an increased cooling performance is achieved, but also that the release of reactive substances from the interior of the battery or the battery cell can be reduced or even prevented. Contamination of the environment with such hazardous substances or compounds is therefore prevented. Gel extinguishants of this kind are known to the skilled person. The preparation, use, and composition of a selection of suitable gel extinguishants are described for example in U.S. Pat. No. 3,229,769, U.S. Pat. No. 5,849,210, and WO 2006/056379. Examples of known gel extinguishants suitable for use in the method of the invention are the following commercially available products:

### 1. Hydrex®

The product is sold by Öko-Tec.

The Hydrex® extinguishant, like Firesorb® and Prevento®, is a gel extinguishant which is present in a powdery consistency and is mixed only in the event of deployment. Hydrex® was the first gel extinguishant on the market.

Hydrex® is an extinguishant additive present as a powder. Admixing 1% to a 10 l capacity stirrup pump produces, within a short time, a gelatinous liquid having a very high capacity for absorbing fire heat. The chemical basis of Hydrex® are gel formers based on water-absorbing polymers.

### 2. Prevento®:

Prevento® is an innovative extinguishant from the manufacturer BASF (see WO 2006/056379).

The Prevento® formulation comprises:

1.0% by weight water-absorbing polymer

1.1% by weight tripotassium citrate

0.2% by weight xanthan (swelling agent)

0.12% by weight polyethylene glycol (solubilizer)

0.2% by weight biocide (stabilizer for the longevity of premix solutions)

### 3. Firesorb®:

The product is sold by Evonik, formally Degussa-Stockhausen.

The formulation comprises sodium acrylate/acrylamide copolymer and fatty acid esters in the form of a W/O emulsion. As solubilizers, isotridecyl polyglycol ether or polyglycol ether is used. For stabilizing the premix solution for a longevity of two years in the fire extinguisher, a biocide is admixed.

The aqueous solution of a Ca salt and the gel extinguishant are preferably applied simultaneously. Simultaneously here means an application in which, at least over a measureable time period, both the aqueous solution of a Ca salt and the gel extinguishant are employed. It is immaterial here whether one of the two extinguishants is applied overall over a longer or a shorter period of time than the other extinguishant, provided there is a measurable time period in which both extinguishants are employed simultaneously.

The aqueous solution of a Ca salt and the gel extinguishant may also be applied in the form of a joint, integrated extinguishant. For this purpose it is possible for not only all or parts of the solid constituents of the gel extinguishant but also all or parts of the salt constituents of the aqueous solution to be present first of all in solid form, as a powder, for example, and to carry out mixing with water or solvent only when the extinguishant is deployed.

In the method of the invention, the two extinguishants may be applied, for example, directly to the object to be treated, or applied over the object to be treated, or applied in the area surrounding the object to be treated. The aqueous solution of a Ca salt is preferably applied in a finely divided form, more preferably as spray mist, very preferably as spray mist having an average droplet diameter of 0.0003 mm to 0.01 mm, preferably having an average droplet diameter of 0.001 mm to 0.005 mm. Spray mists of this kind can be achieved, in particular, utilizing a fine-spray technology. One advantage of the fine-spray technology is to be seen in the very large surface area of the sprayed medium, which is particularly favorable for effective binding of smoky gas. The large surface area of the sprayed medium is achieved as a result of the very small droplet diameters of 0.001 mm-0.005 mm and through a spraying pressure of 60 bar to 100 bar. Droplets of this diameter have a gaseous suspension behavior. The ultrafine water droplets of the high-pressure water mist technology have the advantage over the droplet spectrum of the water spray units which are operated in the pressure range between 5 bar and 15 bar of the capacity for greater heat absorption as a result of the large surface area, which also provides more effective management of the absorption of the harmful gases produced. A side effect which is of advantage for the disposal of the contaminated extinguishing water is the low quantity of extinguishant employed.

The present invention also relates to an extinguishing system for implementing the method of the invention. By an extinguishing system is meant the functional and physical arrangement of extinguishers, such that a fire in one or more battery cells in an object to be protected or in a room to be protected can be controlled, or any such fire can be prevented. For this purpose, the extinguishing system comprises at least two different extinguishers, a first extinguisher being designed such that with this extinguisher, an aqueous solution of a Ca salt can be applied, and a second extinguisher being designed such that with this extinguisher a gel extinguishant can be applied.

One, two or more or all of the extinguishers in the extinguishing system of the invention may be designed as mobile extinguishers, preferably as portable extinguishers, in the form, for example, of conventional fire extinguishers, provided either with an aqueous solution of a Ca salt or with a gel extinguishant.

One, two or more or all of the extinguishers in the extinguishing system of the invention may be designed as stationary extinguishers. For this purpose, preferably, one, two or more or all of the extinguishers may be designed as extinguishant lines having one or more openings, nozzles, sprinklers and/or other devices for the application of the aqueous solution of a Ca salt and/or of the gel extinguishant. In one preferred embodiment, at least one extinguisher, for the application of the aqueous solution of a Ca salt, is designed as a high-pressure circuit line having one or more openings, nozzles or sprinklers, thereby making it possible to generate a spray mist having an average droplet diameter of 0.0003 mm to 0.01 mm, preferably having an average droplet diameter of 0.001 mm to 0.005 mm. For this purpose the high-pressure circuit line may be designed such that it attains a spraying pressure of 60 bar to 100 bar. In designing the amount to be used of Ca salt solution which is distributed via high-pressure water mists, an extinguishant demand of 6 l/m³×min for a deployment time of 10 minutes should be envisaged, which is determined by the deployment time of the plant fire service. The German safety institution VdS additionally requires a deployment margin of 100%.

The gel extinguishant as well, e.g. Firesorb® in the form of a 2% premix solution, can be provided by means of an extinguisher in the form of a high-pressure circuit line, under a holding pressure of 10 bar, for example. The longevity of the solution may be ensured, for example, through the addition of biocides, for a relatively long time period. In a reservoir pressure vessel belonging to the high-pressure circuit line, with a pressurized gas cushion of 0.75 m³, for example, the gel extinguishant, a 2% strength Firesorb® solution, for example, is held, and can be applied via a pipeline with multi-function nozzle in the event of deployment.

One, two or more or all of the extinguishers in the extinguishing system of the invention may be manually deployable, by way of a press-button high-speed deployment means, for example. Alternatively or additionally, these extinguishers may also be deployable automatically, by means of control and/or regulation means—triggered, for example, via one or more PLC controls (PLC stands for programmable logic controller). These control and/or regulation means may be associated, for example, with sensors or detectors, which are able to monitor the status of one or more battery cells, thereby allowing the extinguishing system to be deployed automatically on recognition of the onset of a fire event.

The invention also relates to an apparatus for the safe storage, transportation and/or testing of battery cells, preferably lithium ion cells. The apparatus has an interior compartment for accommodating one or more battery cells. The interior compartment may be wholly or partly separate from the surroundings, by means, for example, of one or more walls, floors, ceilings and/or doors. An apparatus of the invention of this kind may be, for example, a closed or open transport container, a closed or open storage container and/or a test bench for one or more battery cells, battery modules or battery architectures. The apparatus for the safe storage, transportation and/or testing of battery cells has at least one extinguishing system of the invention. This may be an extinguishing system with mobile and/or stationary extinguishers. In addition, the apparatus may have one or more sensors or detectors for monitoring the status of one or more battery cells; the sensor or detector is preferably selected from UV/IR sensors, pressure sensors, smoke alarms, gas sensors and/or temperature sensors. The apparatus of the invention may additionally have control and/or regulation means, e.g., PLC controls, for the automatic deployment of the extinguishing system. Furthermore, the apparatus of the invention may have one or more suction withdrawal systems designed such that gases can be drawn off under suction from the interior compartment for accommodating one or more battery cells; the suction withdrawal system is preferably separated by a bursting disk from the interior of the apparatus.

The present invention also relates to the use of an aqueous solution of a Ca salt and a gel extinguishant for controlling and/or preventing a fire in one or more battery cells, preferably one or more lithium ion cells.

The invention is explained below exemplarily, using working examples.

Comparative extinguishing trials were carried out with different extinguishants. The extinguishing trials were carried out manually in other words, not automatically or via extinguishing units.

For these trials, in part, portable fire extinguishers, capacity 6 l with multi-function sprayer, of Total Walther ISOGARD type, were used and were filled accordingly with extinguishant.

Extinguishants used were the following extinguishants:
A) an aqueous 20% strength CaCl₂ solution (6 l fire extinguisher with sprayer)

B) Firesorb®, 2% mixture (6 l fire extinguisher with sprayer)
C) water (6 l fire extinguisher with sprayer)
D) carbon dioxide, conventional 5 kg extinguisher

The trials were carried out using standard commercial lithium ion cells, freely available on the market, from the Korean company Kokam. More specifically, these are what are known as lithium ion polymer cells, also referred to as pouch cells or soft packs (packaging material consists of composite aluminum foil). According to the data sheet from the Korean cell manufacturer, Kokam, the active cathode material consists of a blend of lithium nickel cobalt manganese oxide (LiNiCoMnO₂) and lithium cobalt oxide (LiCoO₂). The conductive salt used in this Kokam cell is LiPF₆. The nominal capacity of the cells is 4 Ah. Six Li ion modules, each consisting of ten pouch cells (4 Ah Kokam), were operated in thermal runaway in succession by overloading one cell of the modules in each case (initial voltage 4.2 V, charging current 8 A). As a result, all of the modules in question caught fire, and were extinguished with different extinguishants. The trial series are identified below as T1 to T4. During the trials, the extinguishants dripping from the modules (no successful extinguishing with CO₂, final extinguishing with a water extinguisher) were collected in a plastic trough and the samples were assayed for anions and cations.

The extinguishants used are assigned the following trial designations:
T1: C, water extinguisher
T2: Two extinguishers simultaneously: A and B, Firesorb® in water (gel extinguishant) and CaCl₂ in water; overloading of an outer cell of the module
T3: Two extinguishers simultaneously: A and B, Firesorb® in water (gel) and CaCl₂ in water; overloading of a central cell of the module
T4: D, CO₂ extinguisher; subsequently water extinguisher C

### Cation Determination:

The extinguishing water samples were filtered and ICP-AES was used to assay the elements calcium, cobalt, lithium, manganese, and nickel. The results are set out in table 1.

TABLE 1
Cation concentrations in extinguishing water samples T1 to T4

| Sample | Ca [ppm] | Co [ppm] | Li [ppm] | Mn [ppm] | Ni [ppm] |
|---|---|---|---|---|---|
| T1 | 39.74 ± 0.31 | 83.07 ± 0.28 | 95.43 ± 1.08 | <3.29 | 5.56 ± 0.19 |
| T2 | 29630 ± 1.05 | 97.88 ± 0.54 | 78.49 ± 0.44 | <3.29 | 25.34 ± 0.65 |
| T3 | 21960 ± 0.47 | 508.7 ± 0.13 | 173.9 ± 1.19 | <3.29 | 29.60 ± 0.37 |
| T4 | 40.61 ± 5.94 | 222.4 ± 3.19 | 83.19 ± 2.25 | <3.29 | 28.90 ± 3.88 |

### Anion Determination:

The extinguishing water samples were filtered and ion chromatography was used to determine the anions fluoride, chloride, and phosphate. The results are set out in table 2. DL stands for the detection limit in the measurement technique employed:

DL for fluoride: 0.2 ppm

DL for phosphate: 2.0 ppm

Samples T1 and T4 were measured with 1:10 dilution. For the detection of chloride in samples T2 and T3, it was necessary to dilute the samples 1:1000. For detection of phosphate, all of the samples were additionally injected without dilution. In addition, for the detection of fluoride, samples T2 and T3 were used without dilution.

TABLE 2
Anion concentration in extinguishing water samples T1 to T4

| Sample | Fluoride [ppm] | Chloride [ppm] | Phosphate [ppm] |
|---|---|---|---|
| T1 | 35.5 | 60.3 | Below DL |
| T2 | Below DL | 51766.0 | Below DL |
| T3 | Below DL | 39493.0 | Below DL |
| T4 | 152.3 | 70.8 | Below DL |

### Summary of the Trials:

The Kokam cells to which the extinguishants were applied following flame phenomena, with a time delay of 10 seconds, showed initially that the CaCl₂ solution took down the resultant smoke and secondly that the Firesorb® gel extinguishant absorbed the heat in such a way that the flames did not transfer to the other lithium ion cells.

Carbon dioxide is a totally unsuitable extinguishant. This is evident from the fact that the flames repeatedly flared up again.

Water, applied as a spray jet, likewise brings about extinguishment. The smoke which is formed is taken down. After the end of application of the extinguishant, renewed flaming is visible. The analytical results for T1, however, show the presence of fluoride ions in the extinguishing water.

The joint use of an aqueous CaCl₂ solution and of a gel extinguishant (here Firesorb®) resulted in a surprisingly extremely sharp reduction in fluoride ions in solution in the extinguishing water. Through the use of these two extinguishants it is possible to achieve a significant reduction in the amount of reactive fluorine-containing species such as POF₃ and hydrochloric acid which are liberated and which may enter the environment.

1. A method for controlling and/or preventing a fire in one or more battery cells, preferably lithium ion cells, comprising:
applying an aqueous solution of a calcium salt and a gel extinguishant.

2. The method of claim 1, wherein the aqueous solution of a calcium salt and the gel extinguishant are applied simultaneously.

3. The method of claim 1, wherein the aqueous solution of a calcium salt and the gel extinguishant are applied in the form of a joint, integrated extinguishant.

4. The method of claim 1, wherein the calcium salt of the aqueous solution comprises inorganic calcium salt, preferably CaCl₂, Ca(OH)₂, or a mixture thereof.

5. The method of claim 1, wherein the calcium salt is present in a concentration in the aqueous solution of at least 1% w/v up to and including a saturated solution, preferably of 5% w/v up to and including 40% w/v, more preferably of 10% w/v to 30% w/v, very preferably of 20% w/v.

6. The method of claim 1, wherein the gel extinguishant comprises a water-absorbing polymer.

7. The method of claim 1, wherein the aqueous solution of a calcium salt is applied in finely divided form, preferably as spray mist, more preferably as spray mist having an average droplet diameter of 0.0003 mm to 0.01 mm, very preferably having an average droplet diameter of 0.001 mm to 0.005 mm.

8. The method of claim 1, further comprising:
using an aqueous solution of a calcium salt and a gel extinguishant for controlling and/or preventing a fire in one or more battery cells, preferably a lithium ion cell.

9. An extinguishing system comprising:
at least two different extinguishers, a first extinguisher being designed such that with the first extinguisher, an aqueous solution of a calcium salt can be applied, and a second extinguisher being designed such that with the second extinguisher a gel extinguishant can be applied,
wherein the aqueous solution of a calcium salt and the gel extinguishant are applied to control and/or prevent a fire in one or more battery cells, and
wherein the one or more battery cells are preferably lithium ion cells.

10. The extinguishing system of claim 9, wherein the first, the second or both extinguishers are designed as mobile extinguishers, preferably as portable extinguishers.

11. The extinguishing system of claim 9, wherein the first, the second or both extinguishers are designed as stationary extinguishers, preferably as extinguishant lines having one or more openings, nozzles, sprinklers and/or other devices for the application of the aqueous solution of a Ca salt and/or of the gel extinguishant.

12. The extinguishing system of claim 9, wherein the first extinguisher is designed such that with the first extinguisher an aqueous solution of a calcium salt can be applied as a spray mist.

13. An apparatus for the safe storage, transport and/or testing of battery cells, preferably of lithium ion cells, comprising:
an interior compartment for accommodating one or more battery cells; and an extinguishing system of comprising at least two different extinguishers,
wherein a first extinguisher of the at least two different extinguishers is designed such that with the first extinguisher an aqueous solution of a calcium salt can be applied, and
wherein a second extinguisher of the at least two different extinguishers is designed such that with the second extinguisher a gel extinguishant can be applied.

14. The apparatus of claim 13, further comprising:
one or more sensors for monitoring a status of one or more battery cells,
wherein the one or more sensors are preferably selected from UV/IR sensors, pressure sensors, smoke alarms, gas sensors and/or temperature sensors.

15. The apparatus of claim 13, further comprising:
a suction withdrawal system designed such that gases can be drawn off under suction from the interior compartment for accommodating one or more battery cells,
wherein the suction withdrawal system is preferably separated by a bursting disk from the interior of the apparatus.

16. The apparatus of claim 13 wherein:
the aqueous solution of a calcium salt and the gel extinguishant are applied to control and/or prevent a fire in one or more battery cells, and
the one or more battery cells are preferably lithium ion cells.
